(19) United States
(12) Patent Application Publication
(10) Pub. No.: US 2023/0380627 A1
(43) Pub. Date: Nov. 30, 2023

(54) GRILL GRATE

(71) Applicant: Christian Nicholas Barbu, Freehold, NJ (US)

(72) Inventor: Christian Nicholas Barbu, Freehold, NJ (US)

(21) Appl. No.: 17/752,007

(22) Filed: May 24, 2022

(51) Int. Cl. A47J 37/06; A47J 37/07

(52) U.S. Cl. CPC A47J 37/0694; A47J 37/0786

(57) ABSTRACT

A grill grate for use on a grill can include a plurality of grill rods arranged in parallel and spaced apart, each grill rod including bar end surfaces at opposite ends of each grill rod; and first and second grill connectors, the grill connectors extending in a direction perpendicular to the grill rods and connecting the grill rods by the end surfaces of the grill rods, wherein the grill rods define a substantially pentagonal shape when viewed from the direction of the end surfaces. Each of the grill rods can include a top surface; two upper sides extending downwardly from opposite edges of the top surface; and two lower sides extending downwardly from respective upper sides, wherein the top surface, two upper sides and two lower sides define the substantially pentagonal shape when viewed from the direction of the end surfaces.

### BACKGROUND

### Field

This disclosure is generally related to grills, such as barbeque and related grilling devices.

### Description of the Related Art

Barbecue grills and the grilling of food is well known. As the grilling of food, such as meat and vegetables, becomes increasingly popular, many innovations have been developed related to grills and grilling devices.

Many types of grills, such as, for example, propane gas grills, include a cooking grate the provides a surface for resting foods above a heat source. As is commonly known, the grates typically take the form of spaced apart rods or bars within a frame. The frame is shaped to fit the dimensions of a corresponding grill, and this can be circular, oval, square, or rectangular in shape. The grate is typically made of metal such as steel or iron.

However, different types of grill grates have different types of shortcomings. For example, with some grill grates, the spaces between grill rods is such that small food items such as small pieces of meat and vegetables can easily fall between the grill rods.

Further, with some grill grate designs, the mass of the grill rod material is such that heat is not significantly retained after the heat source, such as a propane flame, is turned off. In such situations, a user tends to keep the heat source on for a longer period of time, which can lead to overcooking of the food items.

Still further, with some current grill grate designs, fat, juices and marinades that are released from meats quickly leave or drip off of the grill rods and do not contribute greatly to adding flavor to the food being cooked. On the other hand, with some other grill grate designs, fats and juices are retained at the cooking surface for a relatively long period of time, which can lead to burning, fires and unwanted smoking.

In addition, some grill grate designs incorporate square (in cross-section) shaped rods in which food pieces and particles can be retained and stuck, with the rod shape making it relatively difficult for a user to clean the grill and remove stuck food pieces from between the grill rods.

In contrast, other known grill grate designs use narrow round (in cross-section) rods which contribute, due to their shape, to food sticking to the grill rods. Further, grill grate designs with narrow rods can tend to warp over time due to repeated heating and cooling.

Thus, there is a need in the art for an improved grill grate design that addresses one or more of the above shortcomings of the related art/

### BRIEF SUMMARY

Aspects of the present invention address these and other needs in the art.

In aspects of the invention, a grill grate for use on a grill can include a plurality of grill rods arranged in parallel and spaced apart, each grill rod including bar end surfaces at opposite ends of each grill rod; and first and second grill connectors, the grill connectors extending in a direction perpendicular to the grill rods and connecting the grill rods by the end surfaces of the grill rods, wherein the grill rods define a substantially pentagonal shape when viewed from the direction of the end surfaces.

In some aspects of the invention, each grill rod can include a top surface; and two upper sides extending downwardly from opposite edges of the top surface; and two lower sides extending downwardly from respective upper sides, wherein the top surface, two upper sides and two lower sides define the substantially pentagonal shape when viewed from the direction of the end surfaces.

In some aspects of the invention, the upper sides extend downwardly from the tip surface at a top angle, and wherein the top angle is in the range of 68.3 to 126.8 degrees. In some aspects of the invention, the top angle is in the range of 87.8 to 107.0 degrees. In some aspects of the invention, the top angle is about 97.6 degrees.

In some aspects of the invention, each of the top sides form a side angle with respective bottom sides, and wherein the side angle is in the range of 103.7 to 192.7 degrees. In some aspects of the invention, the side angle is in the range of 133.0 to 163.0 degrees. In some aspects of the invention, the side angle is about 148.2 degrees.

In some aspects of the invention, the bottom sides meet at a bar edge and form a bottom angle, and the bottom angle is in the range of 33.9 to 63.0 degrees. In some aspects of the invention, the bottom angle is in the range of 43.6 to 53.3 degrees. In some aspects of the invention, the bottom angle is about 48.4 degrees.

In some aspects of the invention, each grill bar defines a top bar height between the top surface and a plane defined by the side corners; a bottom bar height between the plane defined by the side corners and the bar edge; and a top width of the top surface; and the ratio between the top bar height, bottom bar height and top width is about 3:2:1.

In some aspects of the invention, each grill bar defines a top bar top height between the top surface and a plane defined by the side corners, and wherein the top bar height is in the range of 21.0 to 39.0 mm. In some aspects of the invention, the top bar height is in the range of 27.0 to 33.0 mm. In some aspects of the invention, the top bar height is about 30 mm.

In some aspects of the invention, each grill bar defines a bottom bar height between the plane defined by the side corners and the bar edge, and the bottom bar height is in the range of 14.0 to 26.0 mm. In some aspects of the invention, the bottom bar height is in the range of 18.0 to 22.0. In some aspects of the invention, the bottom bar height is about 20.0 mm.

In some aspects of the invention, each top surface of each grill bar has a top width, and the top width is in a range of 7.0 to 13.0 mm. In some aspects of the invention, the top width is in a range of 9.0 to 11.0 mm. In some aspects of the invention, the top width is about 10.0 mm.

In some aspects of the invention, a gap between top surfaces on respective grill grates is in the range of 7.0 to 13.0 mm. In some aspects of the invention, the gap between top surfaces on respective adjacent grill grates is in the range of 9.0 to 11.0 mm. In some aspects of the invention, the gap between top surfaces on respective adjacent grill grates is about 10.0 mm.

In some aspects of the invention, the bottom sides meet at a bar edge and form a bottom angle, and a gap between bar edges on respective adjacent grill grates is in the range of 14.0 to 26.0 mm. In some aspects of the invention, the gap between bar edges on respective adjacent grill grates is in the range of 18.0 to 22.0 mm. In some aspects of the invention, the gap between bar edges on respective adjacent grill grates is about 20.0 mm.

In some aspects of the invention, each of the top sides meet a respective bottom side at a side corner, and a gap between side corners on respective adjacent grill grates is in the range of 1.4 to 2.6 mm. In some aspects of the invention, the gap between side corners on respective adjacent grill grates is in the range of 1.8 to 2.2 mm. In some aspects of the invention, the gap between side corners on respective adjacent grill grates is about 2.0 mm.

In some aspects of the invention, the grill rods are formed of at least one of aluminum, iron and stainless steel. In some aspects of the invention, the grill rods are coated with a non-stick coating.

In some aspects of the invention, a method of forming a grill grate for use on a grill can include forming a plurality of grill rods arranged in parallel and spaced apart, each grill rod including bar end surfaces at opposite ends of each grill rod; and forming first and second grill connectors, the grill connectors extending in a direction perpendicular to the grill rods and connecting the grill rods by the end surfaces of the grill rods, wherein the grill rods define a substantially pentagonal shape when viewed from the direction of the end surfaces.

In some aspects of the method each grill rod can include a top surface; two upper sides extending downwardly from opposite edges of the top surface; and two lower sides extending downwardly from respective upper sides, wherein the top surface, two upper sides and two lower sides define the substantially pentagonal shape when viewed from the direction of the end surfaces.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a perspective view of a grill grate, in accordance with an embodiment of the present invention.

FIG. 2 is a side view of the grill grate of FIG. 1.

FIGS. 3A and 3B are expanded side views of a portion of the grill grate of FIG. 1.

FIG. 4 is a top view of the grill grate of FIG. 1.

FIG. 5 is a bottom view of the grill grate of FIG. 1.

### DETAILED DESCRIPTION

In the following description, certain specific details are set forth in order to provide a thorough understanding of various embodiments of the invention. However, one skilled in the art will understand that the invention may be practiced without these details. In other instances, well-known structures have not been shown or described in detail to avoid unnecessarily obscuring descriptions of the embodiments of the invention.

Reference throughout this specification to “one embodiment” or “an embodiment” or “an example embodiment” or “an illustrated embodiment” means that a particular feature, structure or characteristic described in connection with the embodiment is included in at least one embodiment of the present invention. Thus, the appearances of the phrases such as “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings provided herein are for convenience only and do not interpret the scope or meaning of the claimed invention.

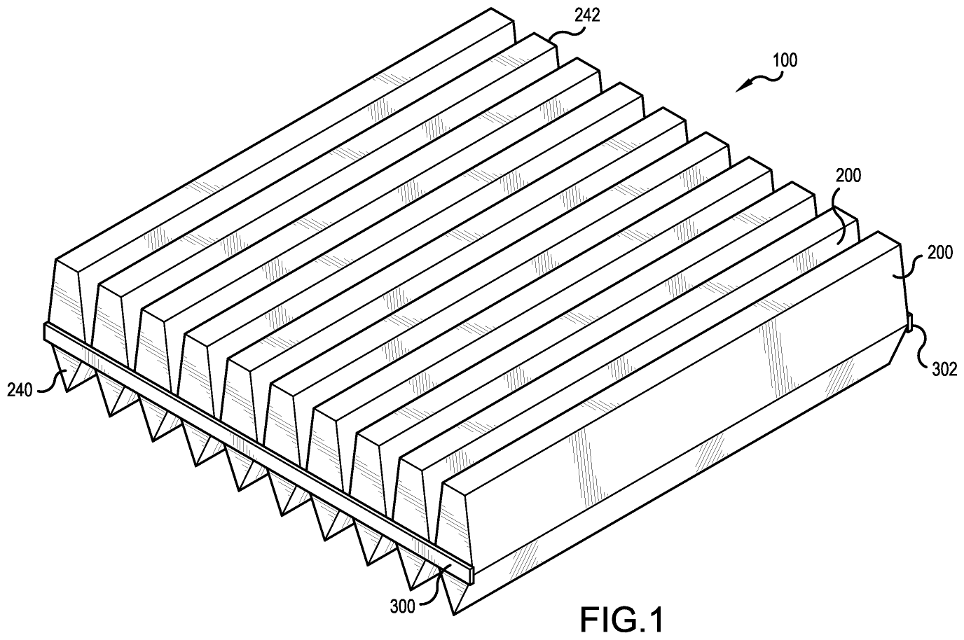

With reference to FIG. 1, there is shown a grill grate 100 in accordance with embodiments of the present invention. Grill grate 100 can include two or more grill bars 200. Grill bars 200 are arranged in parallel and spaced apart. Grill connectors 300, 302 can be located at opposite sides of grill bars 200. Grill connectors 300, 302 serve to maintain the relative position of grill bars 200 and hold grill bars 200 in place.

Grill grate 100 is designed and dimensioned to be placed at a top position of a grill (not shown) as is known in the grilling art. As such, grill grates 100 of various sizes can be formed to include two or more grill bars 200 such that grill grate 100 fits properly on top of a grill, based on the size and shape of a particular grill. For example. grill grate 100 can include from two grill bars 200 up to twelve or more bars 200. Alternatively, other numbers of grill bars 200 can be used as appropriate, depending on the size of a particular grill on which the grill grate 100 will be placed. Further, in some configurations, multiple grill grates 100 can be placed next to each other on top of a grill. For example, four separate grill grates 100, each including three grill bars 220, could be placed on a grill dimensioned for receiving a grill grate 100 including 12 grill bars 200. Other combinations of grill grates 100 and grill bars 200 can be implemented as would be known to those of skill in the art, when informed by the present disclosure.

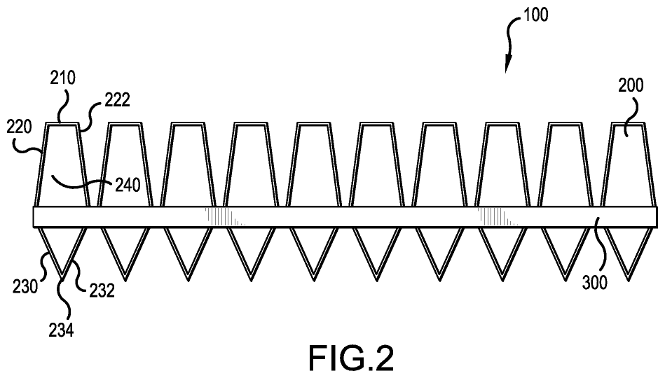

With reference to FIG. 2, and with continued reference to FIG. 1, in accordance with embodiments of the invention, each grill bar 200 has a generally pentagonal shape (i.e., a shape having five sides or surfaces when viewed from the bar 200 ends or in cross section). As such, each grill bar has a flat top surface 210, upper sides 220, 222 extending downwardly from opposite edges of top surface 210. Each grill bar 200 also includes two lower sides 230, 232 extending downward from respective upper sides 220, 222. Upper sides 220, 222 meet lower sides 230, 232 at respective side corners 224, 226.

In some embodiments, lower sides 230, 232 meet at bar edge 234. Each grill bar 200 includes bar ends 240, 242 at opposite sides of each grill bar 200. Each of bar ends 240, 242 are disposed to be oriented perpendicularly to grill top 210, upper sides 220, 222, and lower sides 230, 232. Grill connectors 300, 302 can be attached to respective bar ends 240, 242 of each grill bar 200 to maintain the relative position of multiple grill bars 200. Grill connectors 300, 302 can have a rectangular shape and be formed of a material similar to or different than the material used to form the grill bars 200.

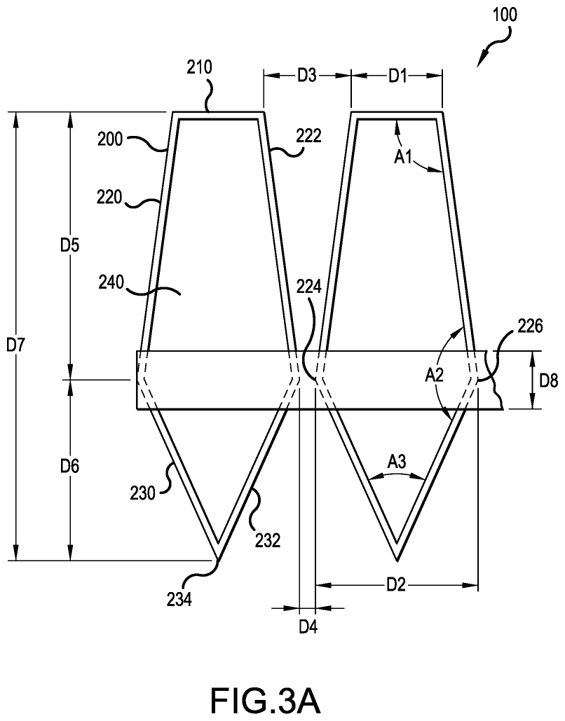

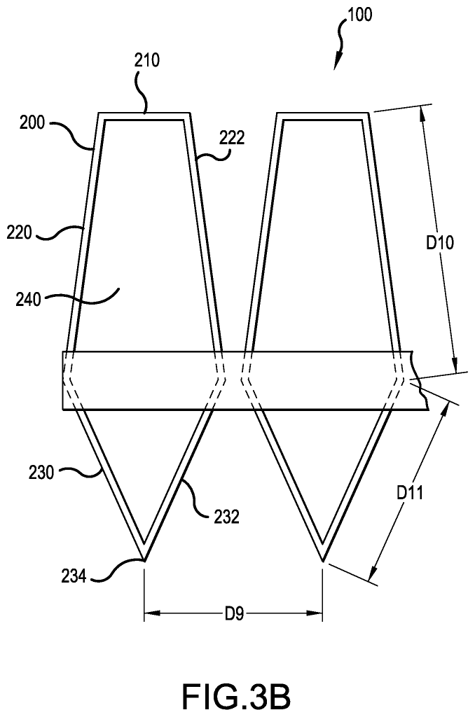

With reference to FIGS. 3A and 3B, as described in further detail below, in embodiments of the present invention, the dimensions and relative orientations of top surface 210, upper sides 220, 222 and lower sides 230, 232 of each grill bar 200 form a generally pentagonal shape.

In certain embodiments, grill bars 200 and grill connectors 300, 302 can be formed of aluminum, Iron, Stainless Steel, or other suitable materials as are known to those of skill in the art, and having a bare (uncoated) finishing or some form of enamel or non-stick coating as is known to those of skill in the art. Grill connectors 300, 302 can be attached to grill bars 200 via welded connections, the use of hardware such as screws, or in another manner, as would be understood by those of skill in the art, when informed by the present disclosure.

As such, in certain embodiments, the various portions of grill bar 200 can have the following dimensions and relative orientations.

In particular, in some embodiments, top surface 210 of grill bar 200 can have a width D1 in the range of 7.0 to 13.0 mm, more preferably in the range of 9.0 to 11.0 mm and most preferably 10.00 mm. Grill bar 200 can have a width D2 (between side corners 224, 226) in the range of 12.6 to 23.4 mm, more preferably in the range of 16.2 to 19.8 mm and most preferably 18.00 mm.

The spacing D3 (i.e., gap) between top surfaces 210 of consecutive adjacent grill bars 200 can be in the range of 7.0 to 13.0 mm, more preferably in the range of 9.0 to 11.0 mm and most preferably 10.00 mm. A spacing D4 (i.e., gap) between adjacent side corners 224, 226 of consecutive adjacent grill bars 200 can be in the range of 1.4 to 2.6 mm, more preferably in the range of 1.8 to 2.2 mm and most preferably 2.00 mm.

A (vertical) distance D5 between a side corner 224 and top surface 210 of grill bar 200 can be in the range of 21.0 to 39.0 mm, more preferably in the range of 27.0 to 33.0 mm and most preferably 30.00 mm. A (vertical) distance D6 between a side corner 224 and bar edge 234 can be in the range of 14.0 to 26.0 mm, more preferably in the range of 18.0 to 22.0 mm and most preferably 20.00 mm.

Further, in certain embodiments, grill bars 200 can be proportioned such that distances D5, D6 and D1 have a general ratio of about 30 mm:20 mm:10 mm or 3:2:1.

Each grill bar can have a bar height D7 in the range of 35.0 to 65.0 mm, more preferably in the range of 45.0 to 55.0 mm and most preferably 50.00 mm. Each grill bar can have a connector width D8 in the range of 3.5 to 6.5 mm, more preferably in the range of 4.5 to 5.5 mm and most preferably 5.00 mm.

Each upper side 220, 222 of grill bar 200 can have a (linear) length D10 of in the range of 21.0 to 39.0 mm, more preferably in the range of 27.0 to 33.0 mm and most preferably 30.2655 mm, while each lower side 230, 232 of grill bar 200 can have a (linear) length of D11 in the range of 15.4 to 28.5 mm, more preferably in the range of 19.7 to 24.1 mm and most preferably 21.9317 mm.

In some embodiments, the distance D9 between respective bar edges 234 of consecutive adjacent grill bars 200 can be in the range of 14.0 to 26.0 mm, more preferably in the range of 18.0 to 22.0 mm and most preferably 20.00 mm.

With regard to the relative orientations of the various portions of grill bars 200, each grill bar 200 can have an angle A1 between top surface 210 and upper sides 220, 222 in the range of 68.3 to 126.8 degrees, more preferably in the range of 87.8 to 107.0 degrees and most preferably about 97.6 degrees.

An angle A2 between each of upper sides 220, 222 and respective lower sides 230, 232 can be in the range of 103.7 to 192.7 degrees, more preferably in the range of 133.0 to 163.0 degrees and most preferably 148.2 degrees. Further an angle A3 between lower sides 230 and 232 of a grill bar 200 can be in the range of 33.9 to 63.0 degrees, more preferably in the range of 43.6 to 53.3 degrees and most preferably 48.4 degrees.

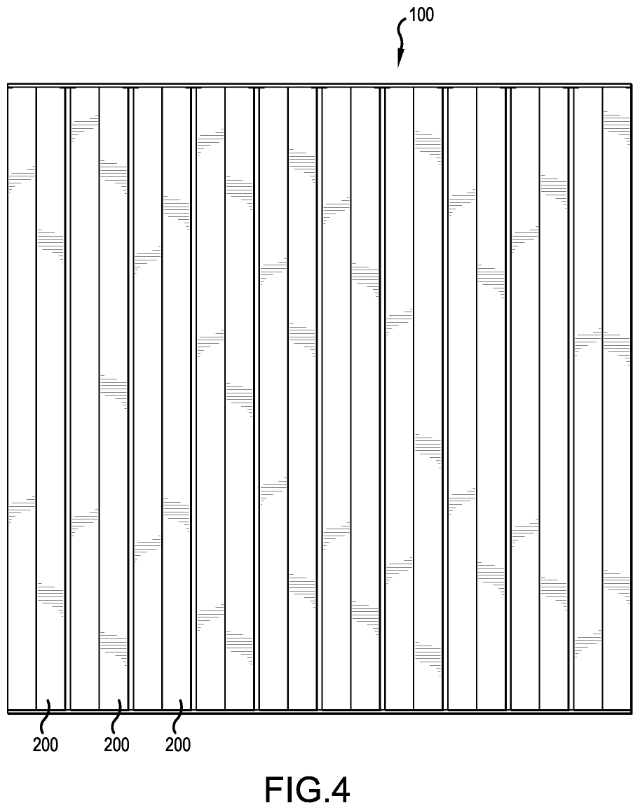

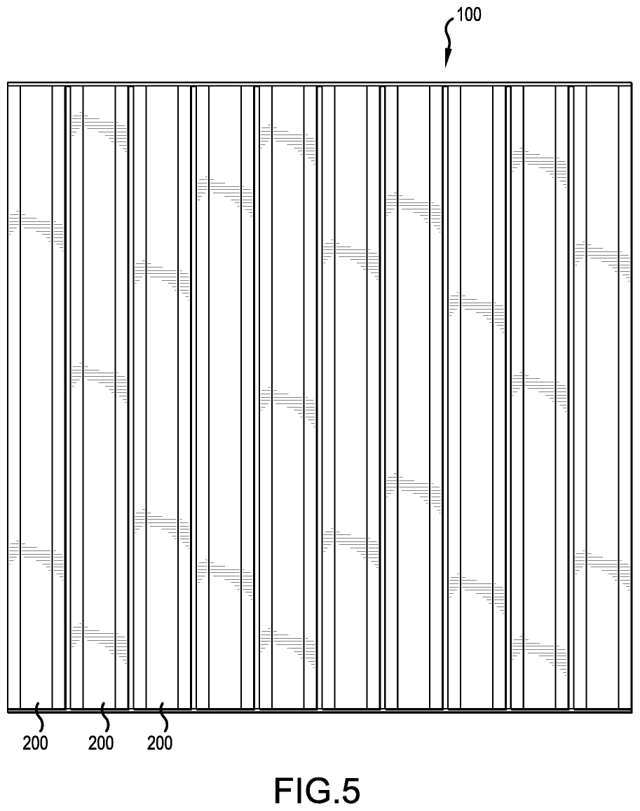

FIGS. 4 and 5 show respective top and bottom views of a grill grate 100 in accordance with certain embodiments.

In some embodiments, as discussed above, grill grate 100, when viewed from the top or bottom, forms a square or rectangular shape, to conform with the shape and structure of a grill for which the grill grate 100 is to be used. In other embodiments, grill grate 100 can be shaped and designed to fit the receiving areas of grills having other shapes, such as, for example, circular or oval-shaped grills. In other embodiments, grill grate 100 can form other shapes, as would be understood by those of skill in the art, when informed by the present disclosure.

In certain embodiments, the pentagonal shape and volume of grill bars 200, as well as the relatively close distance between adjacent grill bars 200 can provide for a relatively long time period for storing thermal energy as well as for dissipating infrared heat energy.

Further, the pentagonal shape of grill bars 200 facilitates cleaning of the grill bars 200 as a user can press a scrubbing tool down the outer angled surfaces of the grill bars 200.

The pentagonal shape of grill bars 200 also allows for beneficial, slow dripping of meat juices, marinades and/or other flavorings, with the juices collecting at a single point of drip down (the bottom tip) of each grill bar 200.

The pentagonal shape of grill bars 200 and spacing (in some embodiments, preferably about 2 mm) between side corners 224, 226 of adjacent grill bars 200 allows for such beneficial dripping of meat juices, as well as facilitating cleaning of the grill bars 200, as discussed above. This is a benefit over other grill bar shapes which may retain meat juices which can lead to fires on a grill grate and burning or overcooking of food.

These features of the present invention provide advantages over related grill bar shapes such a round (i.e., cylindrical) shaped bar grill grates and square shaped bar grill grates.

For example, with round shaped (cross sectional) bar grill grates, the meat juices drip relatively quickly which results in relatively less flavoring since the meat juices drop off of the grill bar quickly.

With square (cross sectional) bar grill grates, food pieces tend to get stuck in corners of the square bars and cause smoke and other problems, such as difficulty in cleaning.

Further, the shape and spacing of the grill bars 200 of the present invention provide for different types of foods to be properly cooked without the problem of food pieces (e.g., salmon steaks or vegetables) falling between the grill bars 200, which can be a problem with related grill grates having round or square grill bars.

Another benefit of embodiments of the present invention is that the pentagonal shape of and spacing between the grill bars 200 provide beneficial thermal heat storage.

By way of this thermal heat storage, the grill bars 200 continue to radiate heat after the fire or heat source of the grill is extinguished, allowing food to continue cooking, if needed.

In addition, the pentagonal shape of grill bars 200 provides for structural stiffness and rigidity which can be resistant to warping as compared to other grill bar shapes.

Further, the triangular bottom shape of grill bars 200 facilitates for heat dissipation along the grill bars 200.

In general, in the following claims, the terms used should not be construed to limit the invention to the specific embodiments disclosed in the specification and the claims. Accordingly, the invention is not limited by the disclosure, but instead its scope is to be determined entirely by the following claims.

What is claimed is:

1. A grill grate for use on a grill, the grill grate comprising:
a plurality of grill rods arranged in parallel and spaced apart, each grill rod including bar end surfaces at opposite ends of each grill rod; and
first and second grill connectors, the grill connectors extending in a direction perpendicular to the grill rods and connecting the grill rods by the end surfaces of the grill rods,
wherein the grill rods define a substantially pentagonal shape when viewed from the direction of the end surfaces.

2. The grill grate of claim 1, wherein each grill rod comprises:
a top surface;
two upper sides extending downwardly from opposite edges of the top surface; and
two lower sides extending downwardly from respective upper sides,
wherein the top surface, two upper sides and two lower sides define the substantially pentagonal shape when viewed from the direction of the end surfaces.

3. The grill grate of claim 1,
wherein the upper sides extend downwardly from the tip surface at a top angle, and
wherein the top angle is in the range of 68.3 to 126.8 degrees.

4. The grill grate of claim 3, wherein the top angle is in the range of 87.8 to 107.0 degrees.

5. The grill grate of claim 4, wherein the top angle is about 97.6 degrees.

6. The grill grate of claim 1,
wherein each of the top sides form a side angle with respective bottom sides, and
wherein the side angle is in the range of 103.7 to 192.7 degrees.

7. The grill grate of claim 6, wherein the side angle is in the range of 133.0 to 163.0 degrees.

8. The grill grate of claim 7, wherein the side angle is about 148.2 degrees.

9. The grill grate of claim 1,
wherein the bottom sides meet at a bar edge and form a bottom angle, and
wherein the bottom angle is in the range of 33.9 to 63.0 degrees.

10. The grill grate of claim 9, wherein the bottom angle is in the range of 43.6 to 53.3 degrees.

11. The grill grate of claim 10, wherein the bottom angle is about 48.4 degrees.

12. The grill grate of claim 1, wherein
each grill bar defines
a top bar height between the top surface and a plane defined by the side corners;
a bottom bar height between the plane defined by the side corners and the bar edge; and
a top width of the top surface; and
wherein the ratio between the top bar height, bottom bar height and top width is about 3:2:1.

13. The grill grate of claim 1, wherein
each grill bar defines a top bar top height between the top surface and a plane defined by the side corners, and
wherein the top bar height is in the range of 21.0 to 39.0 mm.

14. The grill grate of claim 13, wherein the top bar height is in the range of 27.0 to 33.0 mm.

15. The grill grate of claim 14, wherein the top bar height is about 30 mm.

16. The grill grate of claim 1, wherein
each grill bar defines a bottom bar height between the plane defined by the side corners and the bar edge, and
the bottom bar height is in the range of 14.0 to 26.0 mm.

17. The grill grate of claim 16, wherein the bottom bar height is in the range of 18.0 to 22.0.

18. The grill grate of claim 17, wherein the bottom bar height is about 20.0 mm.

19. The grill grate of claim 1, wherein
each top surface of each grill bar has a top width, and
the top width is in a range of 7.0 to 13.0 mm.

20. The grill grate of claim 19, wherein the top width is in a range of 9.0 to 11.0 mm.

21. The grill grate of claim 20, wherein the top width is about 10.0 mm.

22. The grill grate of claim 2,
wherein a gap between top surfaces on respective grill grates is in the range of 7.0 to 13.0 mm.

23. The grill grate of claim 22, wherein the gap between top surfaces on respective adjacent grill grates is in the range of 9.0 to 11.0 mm.

24. The grill grate of claim 23, wherein the gap between top surfaces on respective adjacent grill grates is about 10.0 mm.

25. The grill grate of claim 2,
wherein the bottom sides meet at a bar edge and form a bottom angle,
wherein a gap between bar edges on respective adjacent grill grates is in the range of 14.0 to 26.0 mm.

26. The grill grate of claim 25, wherein the gap between bar edges on respective adjacent grill grates is in the range of 18.0 to 22.0 mm.

27. The grill grate of claim 26, wherein the gap between bar edges on respective adjacent grill grates is about 20.0 mm.

28. The grill grate of claim 1,
wherein each of the top sides meet a respective bottom side at a side corner, and
wherein a gap between side corners on respective adjacent grill grates is in the range of 1.4 to 2.6 mm.

29. The grill grate of claim 28, wherein the gap between side corners on respective adjacent grill grates is in the range of 1.8 to 2.2 mm.

30. The grill grate of claim 29, wherein the gap between side corners on respective adjacent grill grates is about 2.0 mm.

31. The grill grate of claim 1, wherein the grill rods are formed of at least one of aluminum, iron and stainless steel.

32. The grill grate of claim 31, wherein the grill rods are coated with a non-stick coating.

33. A method of forming a grill grate for use on a grill, the method comprising:
forming a plurality of grill rods arranged in parallel and spaced apart, each grill rod including bar end surfaces at opposite ends of each grill rod; and
forming first and second grill connectors, the grill connectors extending in a direction perpendicular to the grill rods and connecting the grill rods by the end surfaces of the grill rods,
wherein the grill rods define a substantially pentagonal shape when viewed from the direction of the end surfaces.

34. The method of claim 33, wherein each grill rod comprises:
a top surface;
two upper sides extending downwardly from opposite edges of the top surface; and
two lower sides extending downwardly from respective upper sides,
wherein the top surface, two upper sides and two lower sides define the substantially pentagonal shape when viewed from the direction of the end surfaces.
